(19) United States
(12) Patent Application Publication
(10) Pub. No.: US 2010/0108107 A1
(43) Pub. Date: May 6, 2010

(54) SYSTEM AND APPARATUS FOR FLUORIDE ION CLEANING

(75) Inventor: Thomas E. Mantkowski, Madeira, OH (US)

Correspondence Address: GENERAL ELECTRIC COMPANY, GE AVIATION, ONE NEUMANN WAY MD F16, CINCINNATI, OH, 45215, US

(73) Assignee: GENERAL ELECTRIC COMPANY

(21) Appl. No.: 12/262,779

(22) Filed: Oct. 31, 2008

(51) Int. Cl. B08B 7/00

(52) U.S. Cl. 134/102.1

(57) ABSTRACT

System and apparatuses for utilizing in-situ generated hydrogen fluoride (HF) in a cleaning process. An exemplary system includes a cleaning retort operable at a temperature sufficient to promote an in-situ reaction between a liquid or gaseous halogenated feedstock and hydrogen gas to form the HF. The system includes a liquid or gaseous halogenated feedstock source and a hydrogen gas source disposed outside the cleaning retort which, upon reaction generate the HF within the cleaning retort. A HF scrubber, disposed within the cleaning retort, is operable to substantially remove residual HF gas formed by the in-situ reaction. An exemplary apparatus includes a cleaning retort having a first region able to hold parts in need of cleaning and a second region operable as a HF scrubber.

### BACKGROUND OF THE INVENTION

This invention relates generally to systems and apparatuses for fluoride ion cleaning, and more specifically to systems and apparatuses operable for in situ generation and capture of hydrogen fluoride gas used to clean components, including components comprising superalloy material.

Fluoride Ion Cleaning (FIC) is used to remove oxides from field-run hot gas path components in preparation for subsequent braze repair operations. Current FIC techniques either suffer from reduced effectiveness due to the limited availability of HF gas in the process or are burdened by high equipment and maintenance costs stemming from the use of bottled HF gas as a reactant.

Commercially available dynamic FIC equipment currently uses bottled HF gas as the source material. Because HF is an extreme toxin, its use requires expensive, relatively complicated equipment in order to safely handle the HF. In addition, since HF must be used in excess in the cleaning process, the effluent stream also contains HF, requiring a scrubber system and it's necessary ancillaries. This combination tends to drive users to employ larger equipment which is segregated from the normal process cells to obtain some economy of scale with the gas handling and treatment systems.

Accordingly, it would be desirable to have an effective cleaning method without the associated downfalls of the use of bottled HF gas a source material. Further, it would be desirable to provide an effective cleaning method that reduces or eliminates the need for a separate scrubber system to remove excess HF from the effluent stream.

### BRIEF DESCRIPTION OF THE INVENTION

The above-mentioned need or needs may be met by exemplary embodiments which provide systems and apparatuses for in-situ generation of HF within a cleaning retort and removes excessive HF before releasing an effluent stream from the cleaning retort.

Exemplary embodiments disclosed herein include a system including a cleaning retort operable at a temperature sufficient to promote an in-situ reaction between a liquid or gaseous halogenated feedstock and hydrogen gas to form hydrogen fluoride (HF). The system also includes a feedstock source for supplying at least one of a liquid or gaseous halogenated feedstock to the cleaning retort, and a hydrogen gas source for supplying hydrogen gas to the cleaning retort, wherein both feedstock source and the hydrogen gas source are disposed outside the cleaning retort. The system further includes a HF scrubber operable to substantially remove residual HF gas formed by the in-situ reaction, wherein the HF scrubber is disposed within the cleaning retort.

Exemplary embodiments disclosed herein include an apparatus comprising a cleaning retort operable at a temperature sufficient to promote an in-situ reaction between a liquid or gaseous halogenated feedstock and hydrogen gas to form hydrogen fluoride (HF), wherein the cleaning retort comprises a first region sized and dimensioned to hold parts in need of cleaning and a second region including a HF scrubber.

### BRIEF DESCRIPTION OF THE DRAWINGS

The subject matter which is regarded as the invention is particularly pointed out and distinctly claimed in the concluding part of the specification. The invention, however, may be best understood by reference to the following description taken in conjunction with the accompanying drawing figures in which:

FIG. 1 is a schematic representation of a high temperature furnace containing a cleaning retort having at least a cleaning region and a scrubbing region.

FIG. 2 is a schematic representation of a high temperature furnace similar in certain respects to the furnace shown in FIG. 1 and including a vacuum pump.

### DETAILED DESCRIPTION OF THE INVENTION

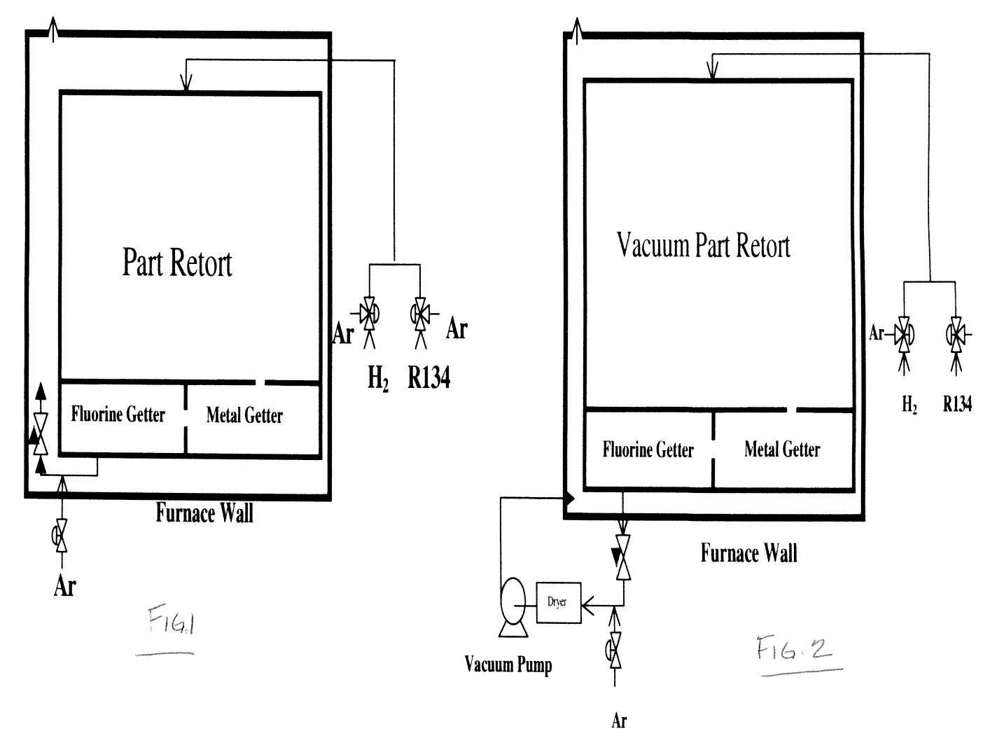

Referring to the drawings wherein identical reference numerals denote the same elements throughout the various views, FIG. 1 shows an exemplary system 10 including a high temperature furnace 12 including a cleaning retort 14 into which parts or components 16 in need of cleaning are placed. Cleaning retort 14 is capable of containing the appropriate cleaning gasses introduced by gas stream 18. The cleaning retort 14 includes at least two regions. A first region 20 is sized and dimensioned to hold parts and components 16 in need of cleaning. A second region 22 is operable as an HF scrubbing unit (fluorine getter). In an exemplary process, the retort 14 is preheated and purged with, for example, argon. Thereafter, a feedstock of a non-hazardous fluorine-containing compound 24 and hydrogen gas 26 are introduced into the retort 12. The fluorine-containing compound reacts at temperature with hydrogen to form HF gas (gas stream 18) in the retort 14.

The HF gas then acts to clean the parts via the conversion of oxides to semi-volatile fluorides which are carried away from the parts or components 16 by the flowing gas stream in a fluoride ion cleaning process. In an exemplary embodiment, prior to exiting the retort, the initial effluent stream 28 is scrubbed of fluorine in the second region 22 (fluorine getter) such that the scrubbed effluent stream 30 exiting the retort is substantially free of fluorine, and therefore less hazardous then in traditional fluoride ion cleaning processes. Optionally, the cleaning retort 14 may include a third region 32 (metal getter) operable to remove a majority of the metals found in the initial effluent stream 28 such as Al and Cr as discussed below.

In an exemplary embodiment, illustrated in FIG. 2, a similar system 100 is utilized. System 100 includes a high temperature furnace 112 including a cleaning retort 114 into which parts or components 116 in need of cleaning are placed. The cleaning retort 114 includes at least regions 120 and 122 operationally similar to regions 20, 22 as described above. Optionally, retort 114 may include region 132 as a metal getter. In an exemplary embodiment, the scrubbed effluent stream 130 is connected to a vacuum pump 140 operable to pulse or modulate pressure in the retort 114 to help evaporate semi-volatile fluorides from the surface of the parts 116 and to provide fresh HF gas 118 into cracks on the parts. A dessicant 142 may be placed in the effluent stream 130 to prevent moisture contamination of the vacuum pump. Alternately, a liquid ring type vacuum pump could be used to provide vacuum without the dryer.

In an exemplary embodiment, hydrogen fluoride gas (HF) is generated and subsequently destructed in-situ, thereby eliminating some of the hazards associated with prior fluoride ion cleaning (FIC) processes. A non-toxic, fluorine-containing compound such as Freon 134a (tetrafluoroethane) is used as a feedstock and thermally decomposed after mixing with hydrogen to form HF:

C₂H₂F₄+5H₂→4HF+2CH₄ (in situ HF generation)

The HF thus generated is utilized in a Fluoride Ion Cleaning process:

6HF+Al₂O₃→2AlF₃+3H₂O

6HF+Cr₂O₃→2CrF₃+3H₂O (cleaning)

H₂O+CH₄→CO+H₂

The effluent stream is treated to remove HF prior to exhausting from the retort. The process has an optional step which removes the majority of the metals found in the initial effluent stream such as Al and Cr. The metal fluoride compounds may be substantially stripped of their metal content so that reconstituted HF may be recycled to the cleaning process. Alternately the reconstituted HF may be more readily removed in a subsequent scrubbing unit.

These elements exist in the effluent stream as fluorides, and can be removed by reducing them to a metal alloy by combining them with a pure sacrificial metal such as iron:

2AlF₃+2Fe+3H₂→2AlFe+6HF (and)

CrF₂+Fe+H₂→CrFe+2HF (metal getting)

In the fluorine removal step, a packed bed is used to contact fluorine-containing species with a sacrificial high melting temperature material. The reactions result in formation of stable, high melting point fluoride compounds which may be subsequently disposed of after the retort has been returned to room temperature. In the preferred embodiment, the fluorine scrubber contains a fluorine getter such as CaO:

2HF+CaO→CaF₂+H₂O (fluorine getting)

Other salts or combinations of salts may replace CaO. For example a combination of CaO and NaCl may be mixed with Si. This fluorine-getter mixture may allow substantially all of the HF to be removed from the gas streams at elevated temperatures. The process generates non-hazardous, readily disposable solid wastes. The gaseous by-products may be combusted in the furnace hot zone resulting in CO₂ and water vapor emissions.

The result of this combination of in-situ generation and destruction of HF allows for tailoring the cleaning processes to the components requiring cleaning, rather than running a single common cycle for all parts regardless of the difficulty of cleaning certain components.

Thus, the exemplary embodiments disclosed herein provide an effective cleaning method without the associated downfalls of the use of bottled HF gas as a source material in situ generation of HF. Further, in situ removal of excess HF from the effluent stream reduces or eliminates the need for a separate scrubber system.

Embodiments disclosed herein present systems and methods of fluoride ion cleaning in which HF gas is generated in-situ in the cleaning retort using a liquid or gaseous halogenated feedstock combined with hydrogen at high temperatures such that no HF precursor material is required to be placed in the cleaning retort prior to initiation of the cleaning cycle and no HF gas is employed as a feedstock

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system comprising:
a cleaning retort operable at a temperature sufficient to promote an in-situ reaction between a liquid or gaseous halogenated feedstock and hydrogen gas to form hydrogen fluoride (HF);
a feedstock source for supplying at least one of a liquid or gaseous halogenated feedstock to the cleaning retort, wherein the feedstock source is disposed outside the cleaning retort;
a hydrogen gas source for supplying hydrogen gas to the cleaning retort, wherein the hydrogen gas source is disposed outside the cleaning retort; and
a HF scrubber operable to substantially remove residual HF gas formed by the in-situ reaction, wherein the HF scrubber is disposed within the cleaning retort.

2. The system according to claim 1 wherein the feedstock comprises at least one of a chlorofluorocarbon (CFC) or hydrofluorocarbon (HFC) compound.

3. The system according to claim 1 wherein the feedstock comprises tetrafluoroethane (HFC-134a).

4. The system according to claim 1 wherein the HF scrubber comprises a packed bed reactor comprising a material capable of forming a stable, non-volatile, high melting temperature fluoride compound upon reaction with HF gas.

5. The system according to claim 4 wherein the material includes CaO

6. The system according to claim 1 further including a metal getter disposed within the cleaning retort, wherein the metal getter is operable to react with at least one of aluminum fluoride (AlF₃) or chromium fluoride (CrF₂) to form a stable, non-volatile, high melting temperature fluoride compound.

7. The system according to claim 6 wherein the metal getter comprises iron.

8. The system according to claim 1 wherein the cleaning retort temperature is in a range of between about 1500 to about 2200° F. (about 816 to about 1204° C.).

9. The system according to claim 1 further comprising:
a mechanism operable to modulating a pressure in the cleaning retort.

10. The system according to claim 9 wherein the pressure modulating mechanism comprises a vacuum pump.

11. An apparatus comprising:
a cleaning retort operable at a temperature sufficient to promote an in-situ reaction between a liquid or gaseous halogenated feedstock and hydrogen gas to form hydrogen fluoride (HF), wherein the cleaning retort comprises a first region sized and dimensioned to hold parts in need of cleaning and a second region including a HF scrubber.

12. The apparatus according to claim 11 wherein the HF scrubber comprises a packed bed reactor comprising a material capable of forming a stable, non-volatile, high melting temperature fluoride compound upon reaction with HF gas.

13. The apparatus according to claim 12 wherein the material comprises CaO.

14. The apparatus according to claim 10 wherein the cleaning retort further comprises a third region comprising a metal getter comprising a non-volatile alloying agent wherein the metal getter is operable to react with at least one of aluminum fluoride (AlF₃) or chromium fluoride (CrF₂) to form a stable, non-volatile, high melting temperature fluoride compound

15. The method according to claim 14 wherein the non-volatile alloying agent is iron.
